(19) United States
(12) Patent Application Publication
(10) Pub. No.: US 2011/0312290 A1
(43) Pub. Date: Dec. 22, 2011

(54) Method and System for Closed Loop Pre-Distortion for PSK/QAM Modulation Using Feedback from Distant End of a Link

(75) Inventors: Michael Beeler, Jefferson, MD (US); Richard Hollingsworth Cannon, Mesa, AZ (US)

(73) Assignee: COMTECH EF DATA CORP., Tempe, AZ (US)

(21) Appl. No.: 13/222,924

(22) Filed: Aug. 31, 2011

Related U.S. Application Data
(60) Provisional application No. 61/510,309, filed on Jul. 21, 2011.

(51) Int. Cl. H04B 1/04; H04B 1/10

(52) U.S. Cl. 455/114.3; 455/295

(57) ABSTRACT

A method of signal distortion correction in a telecommunications channel, the method comprising modeling predicted signal distortion of an electromagnetic (EM) signal using one or more non-linearity model parameters of a signal distortion model, calculating and transferring one or more coefficients of the one or more non-linearity model parameters to a signal transmit location, pre-distorting the signal using an inverse function based on the one or more non-linearity model parameters, and transmitting the pre-distorted signal over the telecommunications channel containing a non-linear amplifier to a remote receiving device.

### CROSS REFERENCE TO RELATED APPLICATIONS

This document claims the benefit of the filing date of U.S. Provisional Patent Application No. 61/510,309, entitled “A Method and System for Closed Loop Pre-Distortion for PSK/QAM Modulation Using Feedback from Distant End of a Link Allowing Long-Loop Delay and Minimum Feedback” to Richard Hollingsworth Cannon et al., which was filed on Jul. 21, 2011 the disclosure of which is hereby incorporated entirely by reference herein.

### BACKGROUND

1. Technical Field

Aspects of this document relate generally to telecommunication systems and techniques for transmitting data across a telecommunication channel.

2. Background Art

This disclosure relates to a method of providing a closed-loop pre-distortion system for Phase Shift Keying (PSK), Amplitude Phase-Shift Keying (APSK) and Quadrature Amplitude Modulation (QAM) to correct the distortive effects of amplifying devices for electromagnetic waveforms. Some electromagnetic systems, such as by non-limiting example, satellite systems, use one electromagnetic (EM) carrier signal per transponder operation and are generally driven near saturation as they are inherently power limited by satellite constraints. As the satellite's amplifier approaches saturation, the system exhibits distortion as Amplitude Modulation to Amplitude Modulation (AM/AM) soft amplitude limiting, and as Amplitude Modulation to Phase Modulation (AM/PM) signal phase rotation as a function of input amplitude.

The distortion introduced by the amplifier's non-linearity causes degraded performance in the link, particularly for complex constellations such as QAM or Multiple ring constellations such as 16-APSK and 32-APSK as exemplified by systems using the DVB-S2 satellite methodology. Thus, a need exists for a system and methodology that creates the ability to ascertain the resulting distortive effects of a waveform at a receiving device and relay the severity of the distortion with a minimum of parameters to the transmitting device.

### SUMMARY

Aspects and applications of the disclosure presented here are described below in the drawings and detailed description. Unless specifically noted, it is intended that the words and phrases in the specification and the claims be given their plain, ordinary, and accustomed meaning to those of ordinary skill in the applicable arts. The inventors are fully aware that they can be their own lexicographers if desired. The inventors expressly elect, as their own lexicographers, to use only the plain and ordinary meaning of terms in the specification and claims unless they clearly state otherwise and then further, expressly set forth the “special” definition of that term and explain how it differs from the plain and ordinary meaning Absent such clear statements of intent to apply a “special” definition, it is the inventors' intent and desire that the simple, plain and ordinary meaning to the terms be applied to the interpretation of the specification and claims.

According to a first aspect, a method of signal distortion correction in a telecommunications channel comprises modeling predicted signal distortion of an electromagnetic (EM) signal using one or more non-linearity model parameters of a signal distortion model, calculating and transferring one or more coefficients of the one or more non-linearity model parameters to a signal transmit location, pre-distorting the signal using an inverse function based on the one or more non-linearity model parameters, and transmitting the pre-distorted signal over the telecommunications channel containing a non-linear amplifier to a remote receiving device.

Particular implementations and embodiments may comprise one or more of the following. The signal distortion model may be a Saleh model having four non-linearity parameters or a Ghorbani model having eight non-linearity parameters. The signal distortion model may be a Rapp model, a Cubic Polynomial model, or a Hyperbolic Tangent model. The method may further comprise mapping an in-phase (I) and quadrature-phase (Q) modulation constellation of the signal, and spectral filtering the signal subsequent to pre-distorting the signal such that one or more spectral qualities of the signal caused by the one or non-linearity model parameters is reduced. The method may further comprise performing non-linear pre-distortion based on feedback from a remote reporting location, the feedback relating to the one or more coefficients of the one or more non-linearity model parameters. Each of the one or more non-linearity model parameters may comprise one or more bytes of data for each of the one or more non-linearity model parameters of the signal distortion model. The method may further comprise performing non-linear pre-distortion based on feedback from a remote reporting location, the feedback relating to an estimated input power backoff coefficient. Each estimated input power backoff coefficients may comprise one or more bytes of data. The method may further comprise calculating an inverse non-linearity model component prior to calculating the one or more coefficients of the one or more non-linearity model parameters based on one or more coefficients received from a remote reporting location. The method may further comprise calculating an input power backoff based on an input power backoff estimation component and a received input power backoff coefficient received from the remote reporting location.

According to another aspect, a method of removing signal distortion from a received signal may comprise receiving a transmitted electromagnetic (EM) signal using a receiving device, the EM signal having been pre-distorted based on one or more coefficients for one or more non-linearity model parameters, demodulating and splitting the received signal using a demodulator such that a first and a second signal results, remodulating the first signal using a replicated original waveform such that samples forming a non-distorted modulation constellation result, storing samples from the second distorted signal in a memory device, comparing the samples from the remodulated first signal and the distorted second signal to obtain amplitude modulation to amplitude modulation (AM/AM) or amplitude modulation to phase modulation (AM/PM) information, outputting comparison information to a distortion to non-linearity model parameter coefficient conversion device, and extracting signal distortion from the received signal such that an original, non-distorted signal results.

Particular implementations and embodiments may comprise one or more of the following. The non-distorted modulation constellation may have a constant radius of points and the modulation format is Binary Phase Shift Keying (BPSK), Quadrature Phase Shift Keying (QPSK) or 8 Phase Shift Keying (8PSK). The method may further comprise demodulating the received signal into one or more samples per symbol. The method may further comprise correcting one or more errors in the demodulated received signal using Forward Error Correction (FEC) over the transmission channel. The method may further comprise remodulating the error corrected signal using one or more samples per symbol. The method may further comprise hard decision decoding of the demodulated received signal. The method may further comprise remodulating the hard decision decoded signal using one or more samples per symbol. The method may further comprise delaying the distorted second signal such that the timing of the distorted second signal matches the timing of the remodulated signal. The method may further comprise comparing the delayed distorted second signal to an original non-distorted signal using one or more samples per symbol. The method may further comprise sampling the remodulated first signal and distorted second signal and collecting amplitude variations between nominal constant radius information samples during periodic data transitions. The method may further comprise calculating an AM/AM curve by curve fitting one or more sets of differences between the received and the remodulated signals plotted as a function of signal amplitude. The method may further comprise calculating an AM/PM curve by curve fitting one or more sets of differences between the received and the remodulated signals plotted as a function of signal phase. The AM/AM curve and the AM/PM curves may be calculated using a Least Mean Squares (LMS) approximation of the sets of differences. The method may further comprise using one or more curve fitting techniques to fit a curve of differences between the constellation points in the non-distorted first signal and distorted second signal, and determining one or more coefficients for one or more non-linearity model parameters using a Look-Up Table (LUT). The one or more coefficients may comprise Alpha and Beta coefficients for both amplitude and phase for four Saleh coefficients. The one or more coefficients may comprise coefficients for both amplitude and phase for eight Ghorbani coefficients. The method may further comprise determining an estimated input power backoff coefficient using a result of the LMS approximation and a Look-Up Table (LUT). The method may further comprise collecting feedback coefficients, wherein each coefficient comprises only a single byte of data, and transmitting the feedback coefficients to a modulator configured to pre-distort the original signal. The feedback coefficients may be transmitted to the modulator for signal pre-distortion using a telecommunications channel.

According to another aspect, a system for signal distortion correction in a telecommunications channel may comprise a signal distortion model configured to modeling predicted signal distortion of an electromagnetic (EM) signal using one or more non-linearity model parameters, a processor configured to calculate one or more coefficients of the one or more non-linearity model parameters, a pre-distorting device configured to pre-distort the signal using an inverse function based on the one or more non-linearity model parameters, and a transmitting device configured to transmit the pre-distorted signal over the telecommunications channel to a remote receiving device.

Particular implementations and embodiments may comprise one or more of the following. The signal distortion model may be a Saleh model having four non-linearity parameters or a Ghorbani model having eight non-linearity parameters. The signal distortion model may be a Rapp model, a Cubic Polynomial model, or a Hyperbolic Tangent model. The system may further comprise a mapping device configured to map an in-phase (I) and quadrature-phase (Q) modulation constellation of the signal, and a filter configured to spectrally filter the signal subsequent to pre-distorting the signal such that one or more spectral qualities of the signal caused by the one or non-linearity model parameters is reduced. The processor may further be configured to perform non-linear pre-distortion based on feedback from a remote reporting location, the feedback relating to the one or more coefficients of the one or more non-linearity model parameters. Each of the one or more non-linearity model parameters may comprise one or more bytes of data for each of the one or more non-linearity model parameters of the signal distortion model. The pre-distorting device may be further configured to perform non-linear pre-distortion based on feedback from a remote reporting location, the feedback relating to an estimated input power backoff coefficient. Each estimated input power backoff coefficient may comprise one or more bytes of data. The processor may be further configured to calculating an inverse non-linearity model component prior to calculating the one or more coefficients of the one or more non-linearity model parameters based on one or more coefficients received from a remote reporting location. The system may further comprise calculating an input power backoff based on an input power backoff estimation component and a received input power backoff coefficient received from the remote reporting location.

According to another aspect, a system for removing signal distortion from a received signal may comprise a receiving device configured to receive a transmitted electromagnetic (EM) signal, the EM signal having been pre-distorted based on one or more coefficients for one or more non-linearity model parameters, a demodulator configured to demodulate and split the received signal such that a first and a second signal results, a modulator configured to remodulating the first signal using a replicated original waveform such that samples forming a non-distorted modulation constellation result, a memory device configured to store samples from the second distorted signal, a processor configured to compare the samples from the remodulated first signal and the distorted second signal to obtain amplitude modulation to amplitude modulation (AM/AM) or amplitude modulation to phase modulation (AM/PM) information and output comparison information to a distortion to non-linearity model parameter coefficient conversion device configured to receive comparison information output by the processor, and an extracting device configured to extracting signal distortion from the received signal such that an original, non-distorted signal results.

Particular implementations and embodiments may comprise one or more of the following. The non-distorted modulation constellation may have a constant radius of points and the modulation format is Binary Phase Shift Keying (BPSK), Quadrature Phase Shift Keying (QPSK) or 8 Phase Shift Keying (8PSK). The demodulator may be further configured to demodulate the received signal into one or more samples per symbol. The system may further comprise an error correction device configured to correct one or more errors in the demodulated received signal using Forward Error Correction (FEC) over the transmission channel. The modulator may further be configured to remodulate the error corrected signal using one or more samples per symbol. The system may further comprise a decoder configured to perform hard decision decoding of the demodulated received signal. The modulator may further be configured to remodulate the hard decision decoded signal using one or more samples per symbol. The system may further comprise a delaying device configured to delay the distorted second signal such that the timing of the distorted second signal matches the timing of the remodulated signal. The processor may further be configured to compare the delayed distorted second signal to an original non-distorted signal using one or more samples per symbol. The processor may further be configured to sample the remodulated first signal and distorted second signal and collect amplitude variations between nominal constant radius information samples during periodic data transitions. The processor may further be configured to calculate an AM/AM curve by curve fitting one or more sets of differences between the received and remodulated signals plotted as a function of signal amplitude. The processor may further be configured to calculate an AM/PM curve by curve fitting one or more sets of differences between the received and remodulated signals plotted as a function of signal phase. The AM/AM curve and the AM/PM curves may be calculated using a Least Mean Squares (LMS) approximation of the sets of differences. The processor may further be configured to use one or more curve fitting techniques to fit a curve of differences between the constellation points in the non-distorted first signal and distorted second signal, and determine one or more coefficients for one or more non-linearity model parameters using a Look-Up Table (LUT). The one or more coefficients may comprise Alpha and Beta coefficients for both amplitude and phase for four Saleh coefficients. The one or more coefficients may comprise coefficients for both amplitude and phase for eight Ghorbani coefficients. The processor may further be configured to determining an estimated input power backoff coefficient using a result of the LMS approximation and a Look-Up Table (LUT). The processor may further be configured to collect feedback coefficients, wherein each coefficient comprises only a single byte of data, and transmit the feedback coefficients to a modulator configured to pre-distort the original signal. The system may further comprise a telecommunications channel configured to transmit the feedback coefficients transmitted to the modulator for signal pre-distortion.

The inventors are also aware of the normal precepts of English grammar. Thus, if a noun, term, or phrase is intended to be further characterized, specified, or narrowed in some way, then such noun, term, or phrase will expressly include additional adjectives, descriptive terms, or other modifiers in accordance with the normal precepts of English grammar. Absent the use of such adjectives, descriptive terms, or modifiers, it is the intent that such nouns, terms, or phrases be given their plain, and ordinary English meaning to those skilled in the applicable arts as set forth above.

Further, the inventors are fully informed of the standards and application of the special provisions of 35 U.S.C. §112, ¶ 6. Thus, the use of the words “function,” “means” or “step” in the Description, Drawings, or Claims is not intended to somehow indicate a desire to invoke the special provisions of 35 U.S.C. §112, ¶ 6, to define the invention. To the contrary, if the provisions of 35 U.S.C. §112, ¶ 6 are sought to be invoked to define the claimed disclosure, the claims will specifically and expressly state the exact phrases “means for” or “step for, and will also recite the word “function” (i.e., will state “means for performing the function of [insert function]”), without also reciting in such phrases any structure, material or act in support of the function. Thus, even when the claims recite a “means for performing the function of . . . ” or “step for performing the function of . . . ,” if the claims also recite any structure, material or acts in support of that means or step, or that perform the recited function, then it is the clear intention of the inventors not to invoke the provisions of 35 U.S.C. §112, ¶ 6. Moreover, even if the provisions of 35 U.S.C. §112, ¶ 6 are invoked to define the claimed disclosure, it is intended that the disclosure not be limited only to the specific structure, material or acts that are described in the preferred embodiments, but in addition, include any and all structures, materials or acts that perform the claimed function as described in alternative embodiments or forms of the invention, or that are well known present or later-developed, equivalent structures, material or acts for performing the claimed function.

The foregoing and other aspects, features, and advantages will be apparent to those artisans of ordinary skill in the art from the DESCRIPTION and DRAWINGS, and from the CLAIMS.

### BRIEF DESCRIPTION OF THE DRAWINGS

Implementations will hereinafter be described in conjunction with the appended drawings, where like designations denote like elements, and:

FIG. 1 is a representation of an implementation of a transmission network using a space-based satellite relay.

FIG. 2 is a representation of an implementation of non-linear AM/AM distortive characteristics modeled by the Saleh approximation method.

FIG. 3 is a representation of an implementation of non-linear AM/PM distortive characteristics modeled by the Saleh approximation method.

FIG. 4 is an example of a 16-QAM modulated waveform without pre-distortion and prior to up-sampling.

FIG. 5 is an example of a 16-QAM modulated waveform without pre-distortion that has been received after passing through a non-linear amplification device.

FIG. 6 is an example of a 16-QAM modulated waveform with pre-distortion and after being up-sampled before passing through a non-linear amplification device.

FIG. 7 is an example of a 16-QAM modulated waveform with pre-distortion and up-sampled at two (2) samples per symbol before passing through a non-linear amplification device.

FIG. 8 is an example of a 16-QAM modulated waveform with pre-distortion after passing through a non-linear amplification device.

FIG. 9 is an example of a 16-QAM modulated waveform with pre-distortion after passing through a non-linear amplification device shown as two (2) samples per symbol.

FIG. 10 is an implementation of a receiving device for demodulating and determining a level of distortion of a signal after passing through a non-linear amplifier.

FIG. 11 is an implementation of a transmitting device that receives input metrics for a level of distortion received after flowing through a non-linear amplification device and applies pre-distortive characteristics to reduce signal distortion.

### DESCRIPTION

This disclosure, its aspects and implementations, are not limited to the specific components, modulation, amplification or frequency examples, or methods disclosed herein. Many additional components and assembly procedures known in the art consistent with non-linear pre-distortion techniques are in use with particular implementations from this disclosure. Accordingly, for example, although particular implementations are disclosed, such implementations and implementing components may comprise any components, models, versions, quantities, and/or the like as is known in the art for such systems and implementing components, consistent with the intended operation.

A method and system for implementing compensation for non-linear distortion of a Radio Frequency (RF) link is described herein. The method assumes that the distortion may be efficiently modeled according to the paper “Frequency Independent and Frequency Dependent Nonlinear Models of TWT amplifiers” by Adel Saleh, IEEE TRANSACTIONS ON COMMUNICATIONS, VOL. COM-29, No. 11, November 1981. A signal is sent through the channel and received by a demodulator. The modulation scheme may be, but is not limited to Phase Shift Keying (PSK), Amplitude Phase Shift Keying (APSK), Quadrature Amplitude Modulation (QAM) or any other applicable modulation format. The modulation scheme is known by the demodulator and the distortion is estimated by comparing the received carrier signal with a decoded and remodulated representation of the received carrier signal. The level of distortion is determined by comparing the received carrier signal (with distortion) to the demodulated and remodulated carrier signal, and determining the difference (amount of distortion) between the two carrier signals on a sample-by-sample basis. Implementations may use a distortion estimation method such as demodulating the received signal and then re-modulating using one or more samples per symbol, and finally comparing the received and re-modulated signal to extract the distortion from the received waveform.

Thus, the ability to ascertain the resulting distortive effects of a waveform at a receiving device, and relay the severity of the distortion with a minimum of parameters to the transmitting device is disclosed herein. Implementations include a method that can be employed for an electromagnetic (EM) emitting device, such as optical or RF transmission equipment for point-to-point, point-to-multipoint and/or multipoint-to-multipoint for collecting and reacting to the pre-distortion information. Pre-distortion is a technique to mitigate degradation by estimating the characteristics of the power amplifier's non-linearity and then multiplying the transmit carrier signal by the inverse of that non-linearity resulting in a waveform that has been inversely affected by the power amplifier's characteristics.

The transmitter computes an inverse compensation from the metrics received from the distant end, and multiplies it with the transmit signal, generally before filtering (usually Nyquist filtering, but this disclosure is not limited as such) to prevent spectral problems caused by the distortion compensation (pre-distortion). Iteration occurs by combining a previous inverse compensation with a subsequent one. Iteration may be intentionally time delayed to provide stability as in some systems (typically satellite) the round trip delay, including processing delay may be on the order of, but not limited to one (1) second.

Particular implementations of a method and system for a closed loop pre-distortion system for PSK/APSK/QAM modulation, or any other appropriate modulation format, using feedback from a distant end of a link, allowing long-loop delay and requiring minimum feedback are disclosed herein and may be specifically employed in satellite communications systems. However, as will be clear to those of ordinary skill in the art from this disclosure, the principles and aspects disclosed herein may readily be applied to any electromagnetic (for example, IF, RF and optical) communications system, such as terrestrial or airborne broadcast networks without undue experimentation.

A method for transmitting an electromagnetic signal in a manner where a Phase Shift Keying (PSK) or Quadrature Amplitude Modulation (QAM) waveform is pre-distorted prior to transmitting over a link that contains a non-linear device. The pre-distortion is performed in a manner that results in minimal or no distortion at the receiving end of the link. In a system that uses pre-distortion, the waveform is pre-distorted to compensate for the distortive characteristics of the non-linear amplifier.

Particular implementations use the received waveform sampled at one or more samples per symbol. In a particular non-limiting embodiment, two-samples per symbol are used, and the received signal is remodulated to become the waveform “without distortion.” A comparison is performed between the received (distorted) waveform and the remodulated (non-distorted) waveform, sample-by-sample, to determine the amount of distortion at each sample. Curve fitting characteristics are then used to determine the coefficients of the non-linearity model parameters that model the derived distortion. Additionally, an estimate may be performed to ascertain the amount of backoff that may be applied to the modulator to bring the signal back into a linear region of the amplifier's modeled characteristics. Additionally, the resulting inverse parameters may be performed at the detection device or at the modulating device. While any appropriate non-linearity model may be used, in a particular embodiment, the Saleh model is used, which has four non-linearity model parameters. Additionally, the Ghorbani model, having eight parameters and also utilizing normalized non-linear transfer functions may be used. Still other known non-linearity models that may be used, however, this disclosure is not limited as such, are the Rapp model, the Cubic Polynomial model, and the Hyperbolic Tangent model.

Particular implementations described herein are and may use, but are not limited to, Field-Programmable Gate Arrays (FPGA), Application-Specific Integrated Circuits (ASIC), Digital Signal Processors, or microprocessors for calculating, interpolating or using a lookup-table (LUT) for the correction vector to estimated non-linearity model parameter coefficient and amplifier backoff. The conversion from correction vector to estimated non-linearity model parameter coefficient and amplifier backoff comprises a curve fitting routine that establishes a normalized power and applies this to the selected non-linearity coefficient model for all correction vectors extracted.

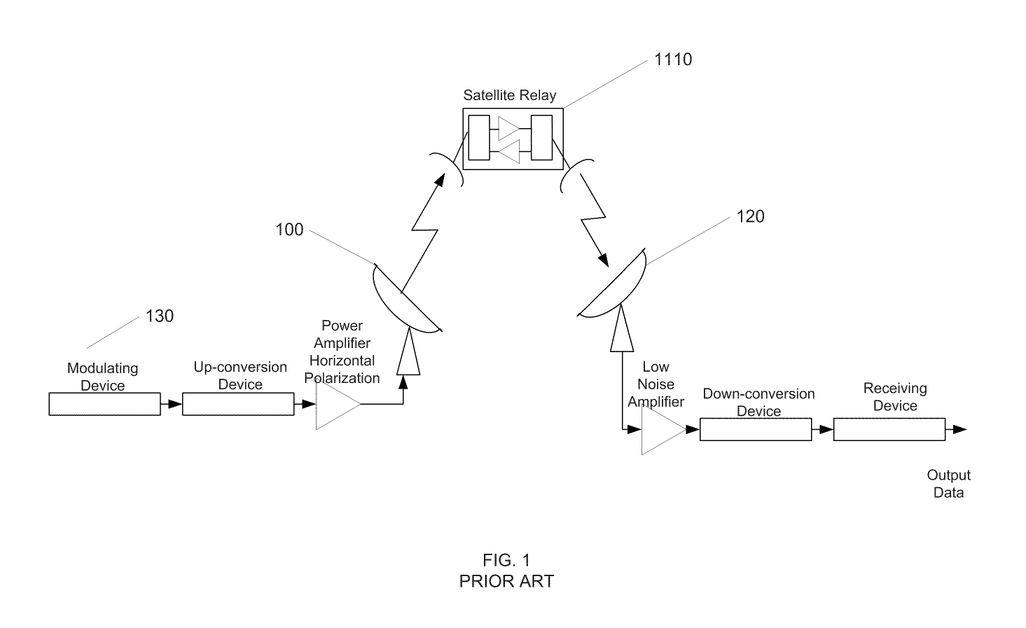

FIG. 1 illustrates a particular implementation of a satellite transmission system comprising a transmission station 100, a satellite repeating relay 110, and a receiving station 120; however, the described method is not limited to satellite transmission systems. The transmitting station 100 and the remote receiving station 120 may be separated by tens, hundreds or thousands of miles. As shown in FIG. 1, the signal flows from the modulating device 130 through each stage (transmission site 100, repeating relay 110, and receiving site 120) that contains power amplification, and results in further distortion of the signal's constellation until being received at the receiving location's low-noise power amplifier and down-conversion device output.

In most typical transmission systems, transmit 100 and receive 120 locations are not the source of non-linear characteristics. The introduction of non-linear characteristics is often introduced by the repeating relay device 110. In particular embodiments, the transmission link and remote relay 110 may operate over one or more of High Frequency (HF), Very High Frequency (VHF), Ultra-High Frequency (UHF), L-Band, S-Band, C-Band, X-Band, Ku-Band and/or Ka-Band, or another suitable communication band. Ground based communications systems are typically operated within the linear mode of operation resulting in minimal, if any, distortion to the transmitted signal, but at the cost of lower efficiency. Since the power system for a ground-based amplifier is more abundant, the lower efficiency is worth the sacrifice for lower signal distortion. However, for airborne or space-based repeating relays, power to the amplifier is a premium, so driving the amplifier at or near saturation is the optimal use of the power. However, running an amplifier at or near saturation may result in distortion to the signal. As shown in FIG. 1, amplifiers in the repeating relay 110, also known as a transponder, may contain a Traveling-Wave Tube Amplifier (TWTA) that exhibits linear characteristics when operated in the linear region of the amplifier's characteristics. However, as the TWTA approaches the 1 decibel (1 dB) compression point, the point at which the input is increased in a linear progression, the resulting output is a one (1) dB drop in the output signal. This is known in the art as the “P1dB” compression point. At P1dB, the amplifier is known to be in compression.

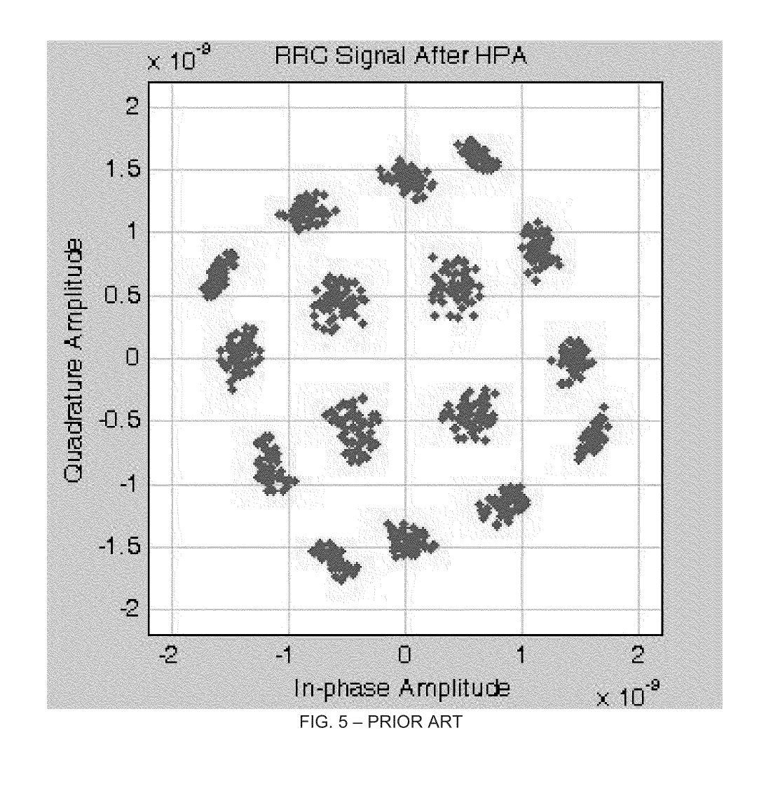

For less complex signals, with constellations on a single ring such as Binary Phase-Shift Keying (BPSK), Quadrature Phase-Shift Keying (QPSK) or 8-Phase Shift Keying (8-PSK), the effects of AM/AM and AM/PM distortion have minimal impact to the transmitted signal. For amplitude modulated waveforms, QAM and APSK, the amplitude modulation portion of the constellation are impacted by the AM-AM distortion. Additionally, the relative rotations of the AM components of the constellation are severely impacted by the independent phase rotation based on the amplitude of the various constellation points as is shown in FIG. 5. As can be observed, the inner constellation points rotate more slowly than the outer points.

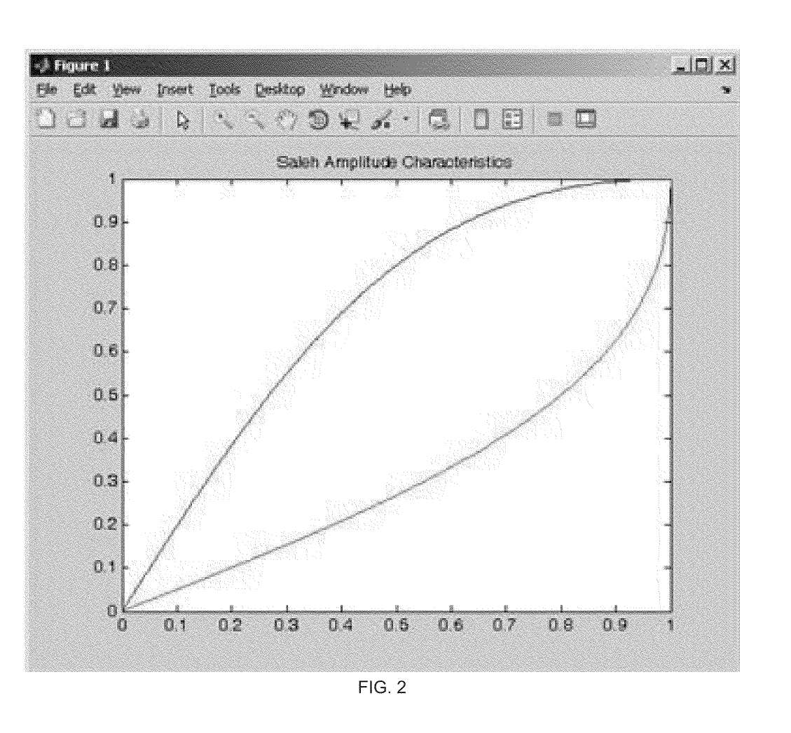

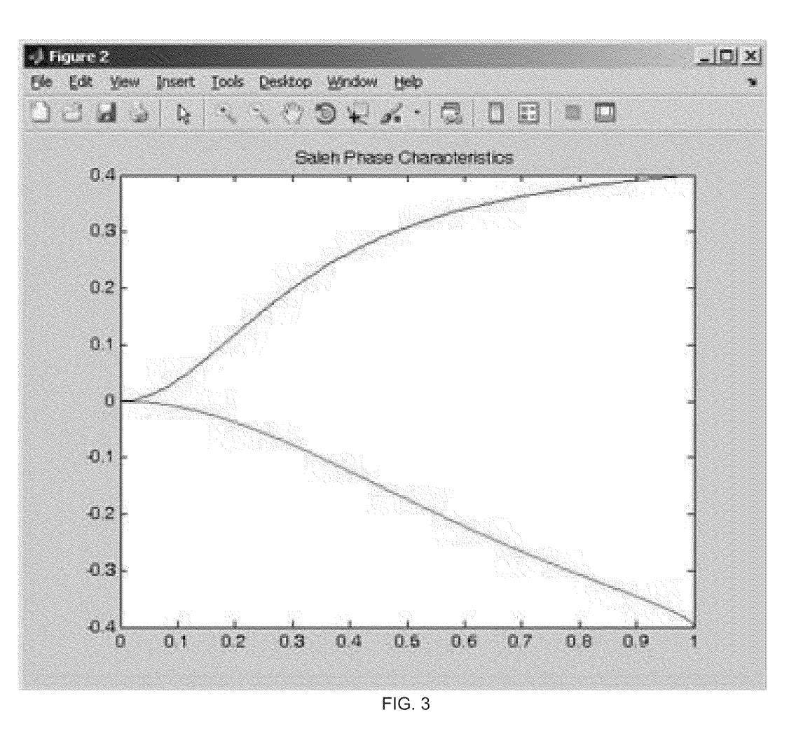

FIG. 2 provides an example of the distortive Amplitude-Amplitude (AM/AM) characteristics of a typical amplifier, such as a Traveling-Wave Tube Amplifier (TWTA), that has been modeled using a method based on the paper “Frequency Independent and Frequency Dependent Nonlinear Models of TWT amplifiers” by Adel Saleh, hereinafter referred to as the “Saleh model.” The parameters used for modeling the AM/AM characteristics is defined by (α_{A}=2, β_{A}=1, α_{Θ}=4, β_{Θ}=9). FIG. 2 represents the modeled AM/AM distortive properties of an amplifier 175 and the inverse of the modeled amplifier 180. Additionally, FIG. 3 shows an example of the distortive Amplitude-Phase (AM/PM) characteristics of a TWTA that has been modeled using the Saleh model 185 and the inverse of the modeled amplifier 190. As can be seen in FIGS. 2 and 3, as the amplitude is driven higher and higher, the Amplitude 175, 185 becomes non-linear and the phase starts to rotate at different angles depending on the input amplitude. The parameters used for modeling the AM/PM characteristics are defined by (α_{A}=2, β_{A}=1, α_{Θ}=4, β_{Θ}=9). The equations as outlined by Saleh are as follows:

$$AM \text{/} AM Distortion : A ( r ) = \frac{{∝}_{a} r}{1 + β {r}^{2}}$$

$$AM \text{/} PM Distortion : θ ( r ) = \frac{{a}_{θ} {r}^{2}}{1 + {β}_{θ} {r}^{2}}$$

In both FIGS. 2 and 3, the modeled Saleh distortive characteristics are shown 175, 185, along with the inverse characteristics 180, 190 that must be utilized to correct for counteracting the distortive characteristics. The inverse Saleh calculations are as follows:

$$Saturation Point : {A}_{s} = 1 - \sqrt{{β}_{A}}$$

$$Inverse AM \text{/} AM : {f}^{- 1} ( r ) = \frac{{∝}_{A} {A}_{S}^{2}}{2 r [ 1 - \sqrt{1 - {( \frac{2 r}{{∝}_{A} {A}_{S}} )}^{2}} ]}$$

$$Inverse AM \text{/} PM : θ ( r ) = - θ ( r )$$

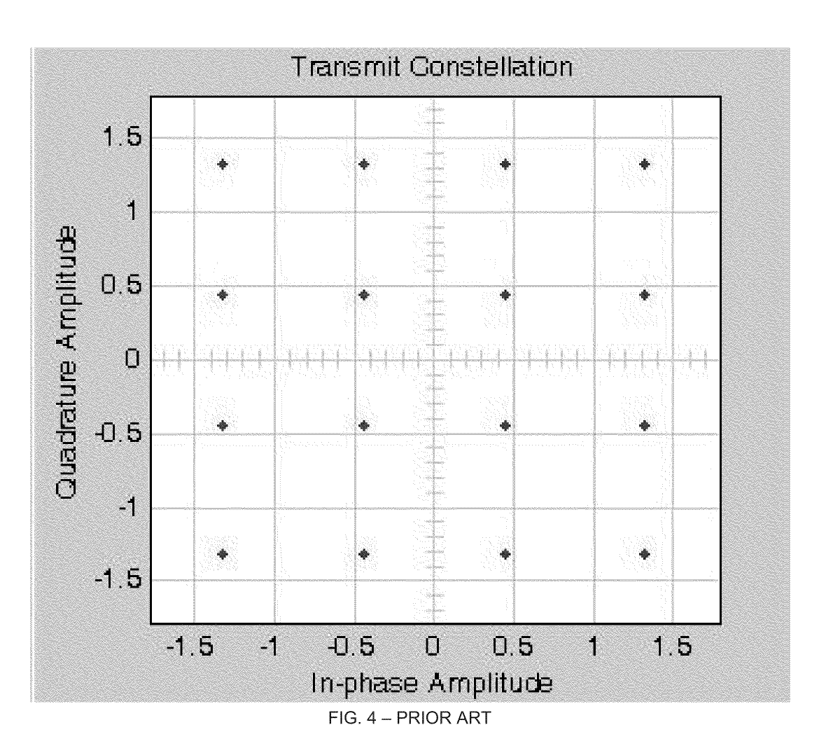

FIG. 4 shows the prior art of a 16-QAM constellation that is created by a constellation mapping device without pre-distortion. A modulating device outputs a non-distorted signal that is represented as an in-phase (I) component on the X-Axis and a quadrature (Q) component on the Y-Axis. Combining both the I and Q components for a 16-QAM waveform (signal), produces 16 points located relative to the center axis that demonstrate a non-distorted waveform.

FIG. 5 shows the resulting distortion of the received up-sampled 16-QAM waveform after flowing through a transmission system having a non-linear amplification device such as a Traveling Wave Tube Amplifier (TWTA) that is running within 1 dB of being in compression. Without pre-distortion, the resulting constellation contains both AM/AM and AM/PM distortion, and the signal received by the receiving device may therefore result in bit errors due to the distortion of the signal.

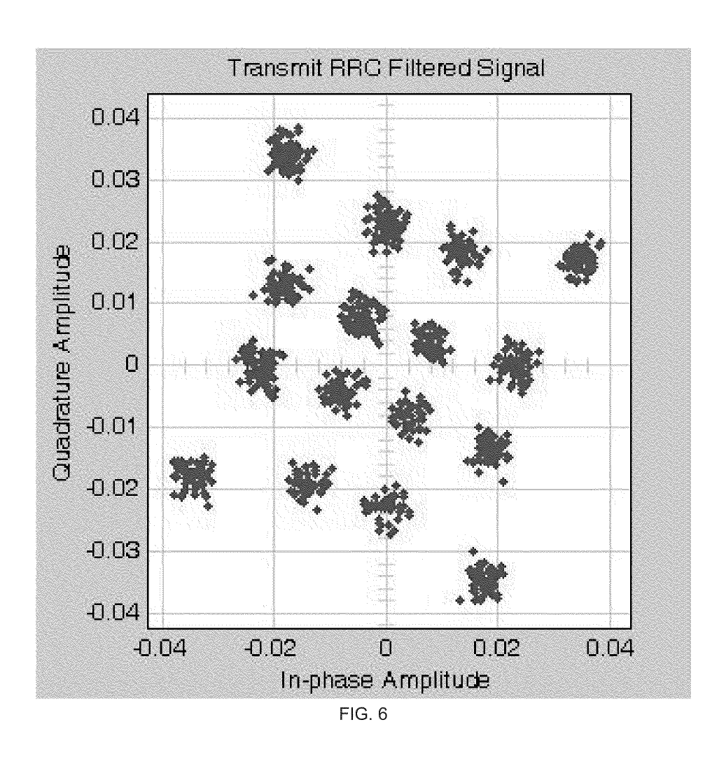

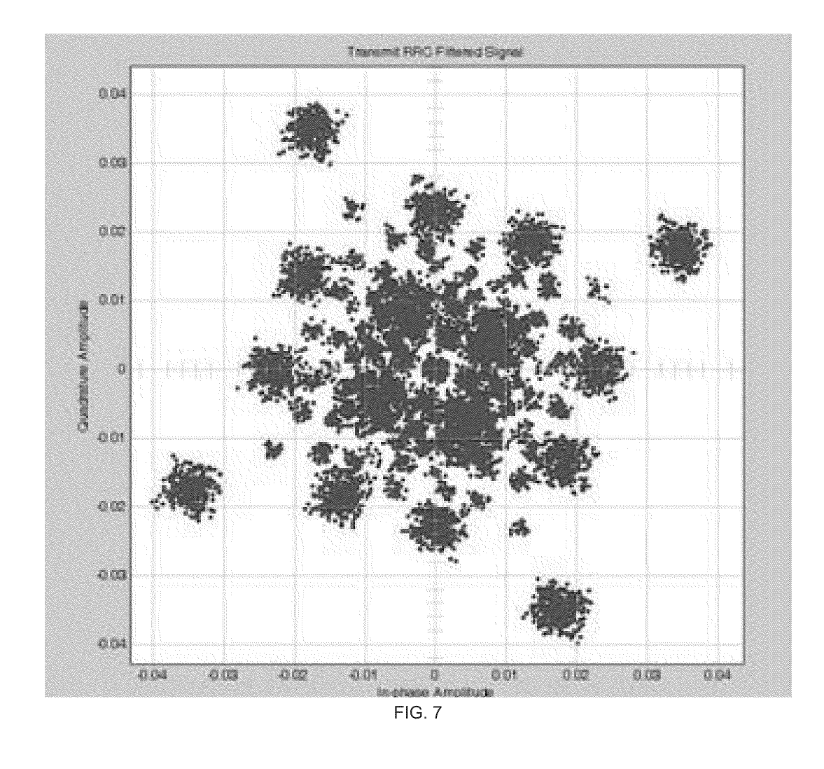

FIG. 6 shows an example of an up-sampled waveform that contains the proper pre-distortion to correct for the distortion introduced by an amplifier operating at or near compression. FIG. 7 shows a representation of an example of the up-sampled waveform at two (2) samples per symbol.

FIG. 6 shows an output of a constellation mapper after pre-distortion of the constellation of FIG. 4 using the inverse Saleh equations and up-sampling (by a pulse shaping Nyquist filter 320 or any other appropriate filter) before transmission. FIG. 7 shows a pre-distorted up-sampled constellation at two (2) samples per symbol. As will be made clear in this disclosure, sampling may be performed at one or more samples per symbol for use of the method.

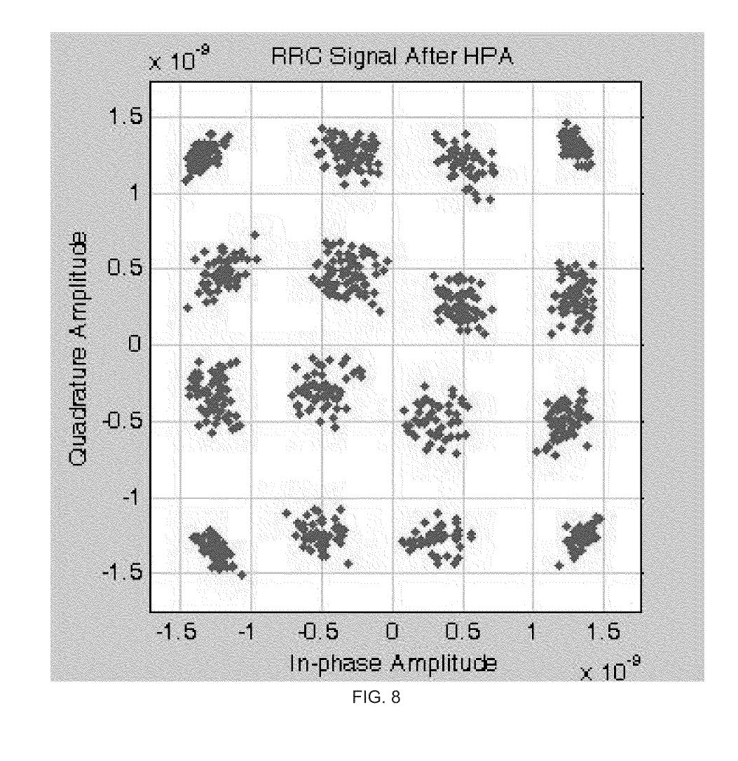

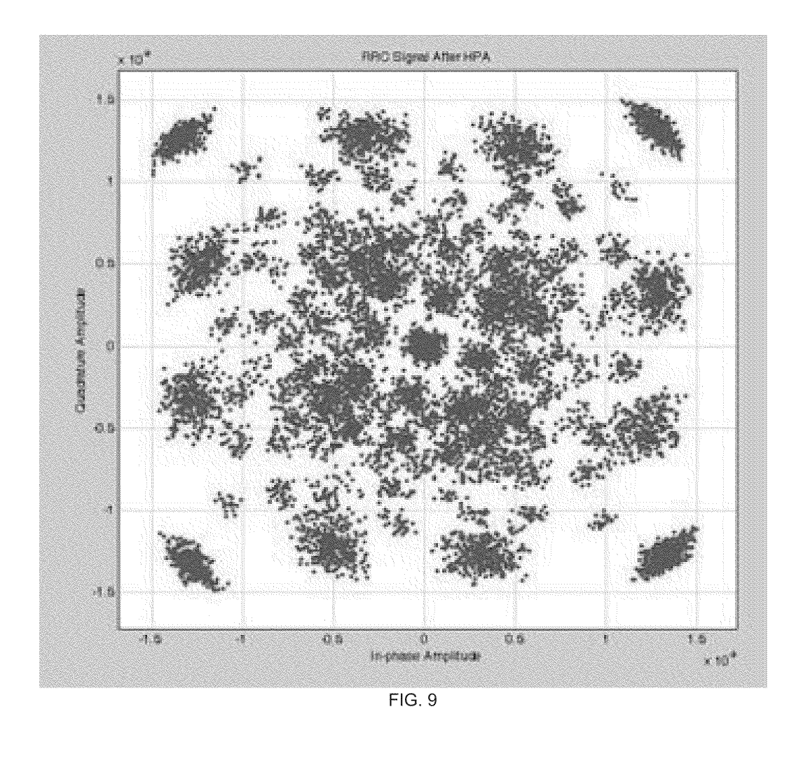

The resulting pre-distorted signals as shown in FIGS. 6 and 7 are the result of a given power, represented as a normalized vector represented as “r,” using the following coefficients: (α_{A}=2, β_{A}=1, α_{Θ}=4, β_{Θ}=9). The resulting output of the pre-distorted carrier signal after passing through a non-linear amplifier is shown in FIG. 8. This output is also shown as two (2) samples per symbol in FIG. 9.

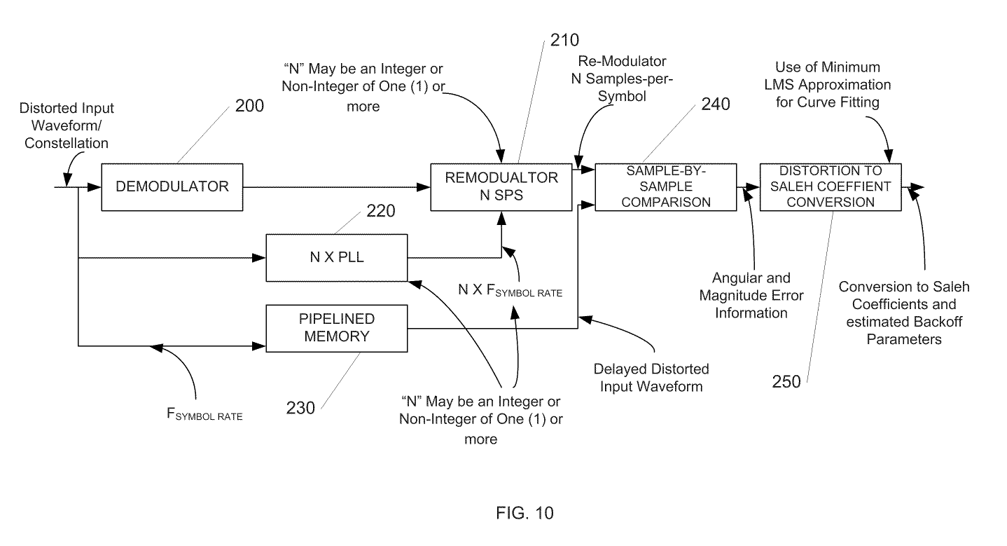

A method for extracting the distortive properties from the received signal may be accomplished by demodulating and storing the received signal and then re-modulating the demodulated signal with one or more samples per symbol, and then comparing the delayed (received) replicated signal to the re-modulated (non-distorted) signal, sample-by-sample, to extract the precise distortion of the signal. An implementation of a receiving device for implementing the methods disclosed herein is shown in FIG. 10. The received signal is input to a demodulator 200 and the second path is provided to a memory device. The output of the demodulator is passed to a remodulator 210 at one or more samples per symbol and remodulation is performed. The method uses a reproduction of the waveform to produce the original (non-distorted) constellation. A Phase-Locked Loop (PLL) 220 is used to up-sample the derived symbol clock by N times, resulting in a one or more samples per symbol sampling clock that is phase locked to the incoming symbol clock. The second path goes into pipelined memory 230 where the symbols are stored. The pipelined memory maintains the original (distorted) symbols, and a sample-by-sample comparison 240 is performed to check the distortion of a remodulated symbol (undistorted) to a received (distorted) symbol. The output is then provided to a distortion to Saleh coefficient conversion device 250.

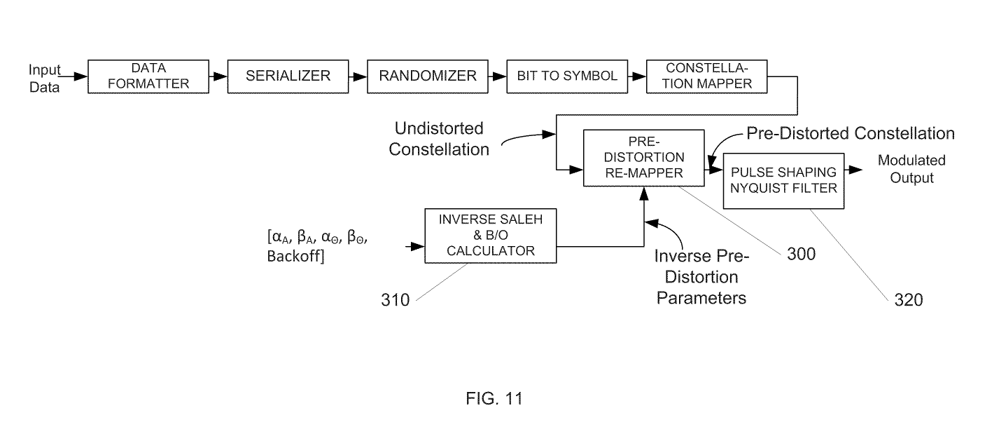

The distortion to Saleh conversion device uses a curve fitting technique to fit the level of distortion represented as a normalized “r” to the proper curve using a Look Up Table (LUT). Once a curve has been approximated, a best fit algorithm may be brought to bear to determine the four Saleh coefficients: [α_{A}, β_{A}, α_{Θ}, β_{Θ}]. Additionally, an estimate may be performed in the logic to determine the estimated backoff that may be applied to incoming signal by the amplifier to provide optimal operation: [Backoff]. The combination of the five parameters [α_{A}, β_{A}, α_{Θ}, β_{Θ}, Backoff] may be represented as five bytes that may be sent via a return channel to the transmit station containing the modulator using the described methods for adjusting the pre-distortion mapper 300. As shown in FIG. 11, a bit to constellation mapping from the bit to symbol and up-sampling section of a modulating device. In an alternate embodiment, the inverse parameter calculations may be performed at the receiving device, but this is not a requirement. The inverse parameter calculations 310 may be performed at either the receiver or the modulator device. In a particular embodiment, and a significant advantage of embodiments of the disclosed systems, the five feedback parameters may be represented as five bytes, where each byte represents a single parameter. Therefore an advantage of some embodiments of disclosed methods and systems is, among other things, that the existing art requires more metrics, resulting in more bandwidth or data to be relayed back to the transmission system, but particular embodiments of the present methods and systems only require a fraction of the information and resulting bandwidth to accomplish the closed-loop control of the design.

The combined method and system results in a closed-loop control mechanism, with a fully automatic and dynamic control system that may adjust the distortion based on a limited number of control metrics that are modeled on the Saleh coefficients.

The following are particular implementations and embodiments of a method and system for implementing compensation for non-linear distortion of a radio frequency link are provided as non-limiting examples:

### Example 1

A space-based satellite relay may be configured to receive an earth-based M-ary QAM carrier signal and relay the carrier signal back to the earth. The signal may be received, amplified and frequency converted, resulting in AM/AM and/or AM/PM distortion. Using an implementation of the described method, a feedback channel is utilized to provide a return path for the control messages. The output power of the transmission device is set to a level that results in the input power backoff (IPBO) on the relay causing the transponder to operate at or near saturation. The distortive effects of the space-based satellite relay, operating at or near saturation, results in the carrier signal's constellation being both distorted by AM/AM and/or AM/PM. Using an implementation of the methods disclosed herein, the five parameters may be extracted and returned to the transmitter location where the signal's pre-distortion parameters are adjusted to compensate for the distortion.

### Example 2

A space-based satellite relay may be configured to receive an earth-based M-ary APSK carrier signal and relay the carrier signal back to the earth. The signal may be received, amplified and frequency converted, resulting in AM/AM and/or AM/PM distortion. Using an implementation of the methods disclosed herein, a feedback channel may be utilized to provide a return path for the control messages. The output power of the transmission device may be set to a level that results in the input power backoff (IPBO) on the relay causing the transponder to operate at or near saturation. The distortive effects of the space-based satellite relay, operating at or near saturation, results in the signal's constellation being both distorted by AM/AM and/or AM/PM. Using an implementation of a method disclosed herein, the five parameters may be extracted and returned to the transmitter location where the signal's pre-distortion parameters are adjusted to compensate for the distortion.

### Example 3

An airborne-based relay may be configured to receive an earth-based M-ary QAM carrier signal and relay the carrier signal back to the earth. The signal may be received, amplified and frequency converted, resulting in AM/AM and/or AM/PM distortion. Using an implementation of a method disclosed herein, a feedback channel may be utilized to provide a return path for the control messages. The output power of the transmission device is set to a level that results in the input power backoff (IPBO) on the relay causing the transponder to operate at or near saturation. The distortive effects of an airborne-based relay, operating at or near saturation, results in the carrier signal's constellation being both distorted by AM/AM and/or AM/PM. Using an implementation of a method disclosed herein, five Saleh parameters may be extracted and returned to the transmitter location where the carrier signal's pre-distortion parameters are adjusted to compensate for the distortion.

### Example 4

An airborne-based relay may be configured to receive an earth-based M-ary APSK carrier signal and relay the carrier signal back to the earth. The signal may be received, amplified and frequency converted, resulting in AM/AM and/or AM/PM distortion. Using an implementation of a method disclosed herein, a feedback channel may be utilized to provide a return path for the control messages. The output power of the transmission device is set to a level that results in the input power backoff (IPBO) on the relay causing the transponder operating at or near saturation. The distortive effects of an airborne-based relay, operating at or near saturation, results in the carrier signal's constellation being both distorted by AM/AM and/or AM/PM. Using an implementation of a method disclosed herein, the five Saleh parameters may be extracted and returned to the transmitter location where the carrier signal's pre-distortion parameters are adjusted to compensate for the distortion.

### Example 5

A terrestrial-based relay may be configured to receive an earth-based M-ary QAM carrier signal and relay the carrier signal. The signal may be received, amplified and frequency converted, resulting in AM/AM and/or AM/PM distortion. Using an implementation of a method disclosed herein, a feedback channel may be utilized to provide a return path for the control messages. The output power of the transmission device is set to a level that results in the input power backoff (IPBO) on the relay causing the transponder to operate at or near saturation. The distortive effects of a terrestrial-based relay, operating at or near saturation, results in the carrier signal's constellation being both distorted by AM/AM and/or AM/PM. Using an implementation of a method disclosed herein, the five Saleh parameters may be extracted and returned to the transmitter location where the carrier signal's pre-distortion parameters are adjusted to compensate for the distortion.

### Example 6

A terrestrial-based relay may be configured to receive an earth-based M-ary APSK carrier signal and relay the carrier signal. The signal may be received, amplified and frequency converted, resulting in AM/AM and/or AM/PM distortion. Using an implementation of a method disclosed herein, a feedback channel may be utilized to provide a return path for the control messages. The output power of the transmission device is set to a level that results in the input power backoff (IPBO) on the relay causing the transponder to operate at or near saturation. The distortive effects of a terrestrial-based relay, operating at or near saturation, results in the carrier signal's constellation being both distorted by AM/AM and/or AM/PM. Using an implementation of a method disclosed herein, the five Saleh parameters may be extracted and returned to the transmitter location where the signal's pre-distortion parameters are adjusted to compensate for the distortion.

### Example 7

In particular embodiments of Examples 1 through 6, the methods disclosed herein may operate iteratively to optimize the transmission parameters, resulting in a carrier signal that contains minimal or no distortive properties when received at the receiving location.

In places where the description above refers to particular implementations of telecommunication systems and techniques for transmitting data across a telecommunication channel, it should be readily apparent that a number of modifications may be made without departing from the spirit thereof and that these implementations may be applied to other to telecommunication systems and techniques for transmitting data across a telecommunication channel.

1. A method of signal distortion correction in a telecommunications channel, the method comprising:
modeling predicted signal distortion of an electromagnetic (EM) signal using one or more non-linearity model parameters of a signal distortion model;
calculating and transferring one or more coefficients of the one or more non-linearity model parameters to a signal transmit location;
pre-distorting the signal using an inverse function based on the one or more non-linearity model parameters; and
transmitting the pre-distorted signal over the telecommunications channel containing a non-linear amplifier to a remote receiving device.

2. The method of claim 1, wherein the signal distortion model is a Saleh model having four non-linearity parameters or a Ghorbani model having eight non-linearity parameters.

3. The method of claim 1, wherein the signal distortion model is a Rapp model, a Cubic Polynomial model, or a Hyperbolic Tangent model.

4. The method of claim 1, further comprising:
mapping an in-phase (I) and quadrature-phase (Q) modulation constellation of the signal; and
spectral filtering the signal subsequent to pre-distorting the signal such that one or more spectral qualities of the signal caused by the one or non-linearity model parameters is reduced.

5. The method of claim 1, further comprising performing non-linear pre-distortion based on feedback from a remote reporting location, the feedback relating to the one or more coefficients of the one or more non-linearity model parameters.

6. The method of claim 5, wherein each of the one or more non-linearity model parameters comprises one or more bytes of data for each of the one or more non-linearity model parameters of the signal distortion model.

7. The method of claim 1, further comprising performing non-linear pre-distortion based on feedback from a remote reporting location, the feedback relating to an estimated input power backoff coefficient.

8. The method of claim 7, wherein each estimated input power backoff coefficients comprises one or more bytes of data.

9. The method of claim 1, further comprising calculating an inverse non-linearity model component prior to calculating the one or more coefficients of the one or more non-linearity model parameters based on one or more coefficients received from a remote reporting location.

10. The method of claim 7, further comprising calculating an input power backoff based on an input power backoff estimation component and a received input power backoff coefficient received from the remote reporting location.

11. A method of removing signal distortion from a received signal, the method comprising:
receiving a transmitted electromagnetic (EM) signal using a receiving device, the EM signal having been pre-distorted based on one or more coefficients for one or more non-linearity model parameters;
demodulating and splitting the received signal using a demodulator such that a first and a second signal results;
remodulating the first signal using a replicated original waveform such that samples forming a non-distorted modulation constellation result;
storing samples from the second distorted signal in a memory device;
comparing the samples from the remodulated first signal and the distorted second signal to obtain amplitude modulation to amplitude modulation (AM/AM) or amplitude modulation to phase modulation (AM/PM) information;
outputting comparison information to a distortion to non-linearity model parameter coefficient conversion device; and
extracting signal distortion from the received signal such that an original, non-distorted signal results.

12. The method of claim 11, wherein the non-distorted modulation constellation has a constant radius of points and the modulation format is Binary Phase Shift Keying (BPSK), Quadrature Phase Shift Keying (QPSK) or 8 Phase Shift Keying (8PSK).

13. The method of claims 11, further comprising demodulating the received signal into one or more samples per symbol.

14. The method of claim 13, further comprising correcting one or more errors in the demodulated received signal using Forward Error Correction (FEC) over the transmission channel.

15. The method of claim 14, further comprising remodulating the error corrected signal using one or more samples per symbol.

16. The method of claim 11, further comprising hard decision decoding of the demodulated received signal.

17. The method of claim 16, further comprising remodulating the hard decision decoded signal using one or more samples per symbol.

18. The method of claim 11, further comprising delaying the distorted second signal such that the timing of the distorted second signal matches the timing of the remodulated signal.

19. The method of claim 18, further comprising comparing the delayed distorted second signal to an original non-distorted signal using one or more samples per symbol.

20. The method of claim 12, further comprising sampling the remodulated first signal and distorted second signal and collecting amplitude variations between nominal constant radius information samples during periodic data transitions.

21. The method of claim 11, further comprising calculating an AM/AM curve by curve fitting one or more sets of differences between the received and the remodulated signals plotted as a function of signal amplitude.

22. The method of claim 11, further comprising calculating an AM/PM curve by curve fitting one or more sets of differences between the received and the remodulated signals plotted as a function of signal phase.

23. The method of claim 21, wherein the AM/AM curve and the AM/PM curves are calculated using a Least Mean Squares (LMS) approximation of the sets of differences.

24. The method of claim 11, further comprising:
using one or more curve fitting techniques to fit a curve of differences between the constellation points in the non-distorted first signal and distorted second signal; and
determining one or more coefficients for one or more non-linearity model parameters using a Look-Up Table (LUT).

25. The method of claim 24, wherein the one or more coefficients comprises Alpha and Beta coefficients for both amplitude and phase for four Saleh coefficients.

26. The method of claim 24, wherein the one or more coefficients comprises coefficients for both amplitude and phase for eight Ghorbani coefficients.

27. The method of claim 23, further comprising determining an estimated input power backoff coefficient using a result of the LMS approximation and a Look-Up Table (LUT).

28. The method of claim 11, further comprising:
collecting feedback coefficients, wherein each coefficient comprises only a single byte of data; and
transmitting the feedback coefficients to a modulator configured to pre-distort the original signal.

29. The method of claim 28, wherein the feedback coefficients are transmitted to the modulator for signal pre-distortion using a telecommunications channel.

30. A system for signal distortion correction in a telecommunications channel, the system comprising:
a signal distortion model configured to modeling predicted signal distortion of an electromagnetic (EM) signal using one or more non-linearity model parameters;
a processor configured to calculate one or more coefficients of the one or more non-linearity model parameters;
a pre-distorting device configured to pre-distort the signal using an inverse function based on the one or more non-linearity model parameters; and
a transmitting device configured to transmit the pre-distorted signal over the telecommunications channel to a remote receiving device.

31. The system of claim 30, wherein the signal distortion model is a Saleh model having four non-linearity parameters or a Ghorbani model having eight non-linearity parameters.

32. The system of claim 30, wherein the signal distortion model is a Rapp model, a Cubic Polynomial model, or a Hyperbolic Tangent model.

33. The system of claim 30, further comprising:
a mapping device configured to map an in-phase (I) and quadrature-phase (Q) modulation constellation of the signal; and
a filter configured to spectrally filter the signal subsequent to pre-distorting the signal such that one or more spectral qualities of the signal caused by the one or non-linearity model parameters is reduced.

34. The system of claim 30, wherein the processor is further configured to perform non-linear pre-distortion based on feedback from a remote reporting location, the feedback relating to the one or more coefficients of the one or more non-linearity model parameters.

35. The system of claim 34, wherein each of the one or more non-linearity model parameters comprises one or more bytes of data for each of the one or more non-linearity model parameters of the signal distortion model.

36. The system of claim 30, wherein the pre-distorting device is further configured to perform non-linear pre-distortion based on feedback from a remote reporting location, the feedback relating to an estimated input power backoff coefficient.

37. The system of claim 36, wherein each estimated input power backoff coefficient comprises one or more bytes of data.

38. The system of claim 30, wherein the processor is further configured to calculating an inverse non-linearity model component prior to calculating the one or more coefficients of the one or more non-linearity model parameters based on one or more coefficients received from a remote reporting location.

39. The system of claim 36, further comprising calculating an input power backoff based on an input power backoff estimation component and a received input power backoff coefficient received from the remote reporting location.

40. A system for removing signal distortion from a received signal, the system comprising:
a receiving device configured to receive a transmitted electromagnetic (EM) signal, the EM signal having been pre-distorted based on one or more coefficients for one or more non-linearity model parameters;
a demodulator configured to demodulate and split the received signal such that a first and a second signal results;
a modulator configured to remodulating the first signal using a replicated original waveform such that samples forming a non-distorted modulation constellation result;
a memory device configured to store samples from the second distorted signal;
a processor configured to compare the samples from the remodulated first signal and the distorted second signal to obtain amplitude modulation to amplitude modulation (AM/AM) or amplitude modulation to phase modulation (AM/PM) information and output comparison information to a distortion to non-linearity model parameter coefficient conversion device configured to receive comparison information output by the processor; and
an extracting device configured to extracting signal distortion from the received signal such that an original, non-distorted signal results.

41. The system of claim 40, wherein the non-distorted modulation constellation has a constant radius of points and the modulation format is Binary Phase Shift Keying (BPSK), Quadrature Phase Shift Keying (QPSK) or 8 Phase Shift Keying (8PSK).

42. The system of claims 40, wherein the demodulator is further configured to demodulate the received signal into one or more samples per symbol.

43. The system of claim 42, further comprising an error correction device configured to correct one or more errors in the demodulated received signal using Forward Error Correction (FEC) over the transmission channel.

44. The system of claim 43, wherein the modulator is further configured to remodulate the error corrected signal using one or more samples per symbol.

45. The system of claim 40, further comprising a decoder configured to perform hard decision decoding of the demodulated received signal.

46. The system of claim 45, wherein the modulator is further configured to remodulate the hard decision decoded signal using one or more samples per symbol.

47. The system of claim 40, further comprising a delaying device configured to delay the distorted second signal such that the timing of the distorted second signal matches the timing of the remodulated signal.

48. The system of claim 47, wherein the processor is further configured to compare the delayed distorted second signal to an original non-distorted signal using one or more samples per symbol.

49. The system of claim 41, wherein the processor is further configured to sample the remodulated first signal and distorted second signal and collect amplitude variations between nominal constant radius information samples during periodic data transitions.

50. The system of claim 40, wherein the processor is further configured to calculate an AM/AM curve by curve fitting one or more sets of differences between the received and remodulated signals plotted as a function of signal amplitude.

51. The system of claim 40, wherein the processor is further configured to calculate an AM/PM curve by curve fitting one or more sets of differences between the received and remodulated signals plotted as a function of signal phase.

52. The system of claim 50, wherein the AM/AM curve and the AM/PM curves are calculated using a Least Mean Squares (LMS) approximation of the sets of differences.

53. The system of claim 40, wherein the processor is further configured to:
use one or more curve fitting techniques to fit a curve of differences between the constellation points in the non-distorted first signal and distorted second signal; and
determine one or more coefficients for one or more non-linearity model parameters using a Look-Up Table (LUT).

54. The system of claim 53, wherein the one or more coefficients comprises Alpha and Beta coefficients for both amplitude and phase for four Saleh coefficients.

55. The system of claim 53, wherein the one or more coefficients comprises coefficients for both amplitude and phase for eight Ghorbani coefficients.

56. The system of claim 52, wherein the processor is further configured to determining an estimated input power backoff coefficient using a result of the LMS approximation and a Look-Up Table (LUT).

57. The system of claim 50, wherein the processor is further configured to:
collect feedback coefficients, wherein each coefficient comprises only a single byte of data; and
transmit the feedback coefficients to a modulator configured to pre-distort the original signal.

58. The system of claim 57, further comprising a telecommunications channel configured to transmit the feedback coefficients transmitted to the modulator for signal pre-distortion.
